(19) United States
(12) Patent Application Publication
(10) Pub. No.: US 2025/0022634 A1
(43) Pub. Date: Jan. 16, 2025

(54) BONDED PAIR HYBRID CABLE

(71) Applicant: CommScope Technologies LLC, Claremont, NC (US)

(72) Inventors: Zachary Clampitt, Conover, NC (US); David Wiebelhaus, Hickory, NC (US); Joseph Lichtenwalner, Newton, NC (US); Wayne Hopkinson, Hickory, NC (US)

(21) Appl. No.: 18/900,732

(22) Filed: Sep. 28, 2024

Related U.S. Application Data
(63) Continuation of application No. PCT/US2023/013902, filed on Feb. 26, 2023.
(60) Provisional application No. 63/325,290, filed on Mar. 30, 2022.

(51) Int. Cl. H01B 9/00; G02B 6/44

(52) U.S. Cl. CPC H01B 9/005; G02B 6/4434

(57) ABSTRACT

A hybrid cable includes at least two bonded pairs of electrical conductors, such as four bonded pairs. The bonded pairs may be stranded about a central member and may also be bonded to each other. In one embodiment, the central member is a GRP rod, and one or two buffer tubes, each containing optical fibers, are stranded along with the bonded pairs about the GRP rod. In another embodiment, the central member is a tube and plural optical fibers are contained within the tube. Each bonded pair of electrical conductors carry digital or class 4 power from a transmitter card to a respective receiver card. Each bonded pair has unique indicia to facilitate the correct connections between the transmitter and receiver cards, such as tactile physical features on an outer surface of one of the electrical conductors of each bonded pair.

This application is a continuation of International Application No. PCT/US2023/013902, filed Feb. 26, 2023, which claims the benefit of U.S. Provisional Application No. 63/325,290, filed Mar. 30, 2022, both of which are herein incorporated by reference.

### BACKGROUND OF THE INVENTION

### 1. Field of the Invention

The present invention relates to a hybrid cable having both electrical conductors for power and optical fibers for data. More particularly, the present invention relates to a hybrid cable wherein plural pairs of electrical conductors are provided in the cable to carry power, such as digital voltage or class 4 power, and each pair is bonded together, and may be bonded to another bonded pair or pairs, and may include indicia to identify each bonded pair from the other bonded pairs.

### 2. Description of the Background

A particularly safe way to transfer high voltage power from a source to a destination is under development and initial deployment and is known as digital voltage or class 4 power. Class 4 power sends rapid pulses of high voltage DC current, e.g., 400 volts. The destination receives the pulses, which may be reduced due to some voltage drop over a long transmission line. The destination has equipment to convert the received DC voltage pulses into a new supply voltage, which is suitable for the equipment at the destination, e.g., a 240 volt or 120 volt AC signal or a 12, 24 or 48 volt DC signal. If any irregularity occurs in the pulses between the source and destination, e.g., due to an intermittent short or open circuit condition, the source immediately, e.g. within a few milliseconds, stops sending the high voltage DC voltage pulses to avoid an unsafe condition.

Several background art references show systems for providing safe, high voltage pulses, e.g., exceeding 300 VDC. Such background art can be found in U.S. Pat. Nos. 8,781,637; 9,184,795; 9,419,436; 9,853,689; 9,893,521; 10,468,879; 10,541,543 and 10,714,930, and in US Published Application Nos. 2017/0229886; 2018/0313886; 2020/0295559 and 2021/0063447, which are owned by VoltServer of East Greenwich, Rhode Island, and are herein incorporated by reference.

In the class 4 power systems, a source unit that produces the pulses of high voltage DC current has plural electronic transmission cards, e.g., four transmission cards, which each have first and second output terminals. A destination unit that receives the high voltage DC current has plural electronic reception cards, e.g., four reception cards, which each have first and second input terminals. First and second insulated conductors connect the first and second output terminals of a corresponding transmission card to the first and second input terminals of a particular reception card. There is often a desire to transmit data between the source and destination area, and a data transmission medium may also exist between the source and destination. See for example, the Assignee's pending PCT Application Serial No. PCT/US2022/053878, filed Dec. 22, 2022, which is herein incorporated by reference. Since both power and data are to be sent between the source area and the destination area, a hybrid cable is well suited for the task.

U.S. Pat. No. 8,792,760, which is herein incorporated by reference, shows a typical hybrid cable 200. The typical hybrid cable 200, as illustrated in FIG. 1A, has a core with eight separate insulated power conductors 210 and six buffer tubes 230, with plural optical fibers 240 in each buffer tube 230, and a central strength member 220. The core is surrounded by a jacket 280. Each of the insulated power conductors 210 includes a color stripe 216 formed on the outside surface of its insulation layer 212. The colors of the stripes 216 are all different from each other. In other words, there are eight different colors to distinguish the eight separate insulated power conductors 210.

Belden Inc. of St. Louis, Missouri offers another hybrid cable 81 for use with class 4 power. FIG. 1B shows the hybrid cable 81, namely a model DHWP162U*D06J, with two twisted pairs 83 and 85 of insulated conductors. The conductors are sixteen American wire gauge (AWG). Six optical fibers 87 are contained within a buffer tube 89. The two twisted pairs 83 and 85 of insulated conductors and buffer tube 89 constitute a core. The core is surrounded by a dielectric jacket 91. Belden also offers various other similar hybrid cables with four twisted pairs of insulated conductors or eight twisted pairs of insulated conductors, and fiber counts of up to twelve.

Other types of hybrid cables with both electrical conductors and optical fibers are generally known in the prior art. For example, see U.S. Pat. Nos. 5,469,523; 6,363,192; 6,734,364; 7,049,523; 7,259,332; 8,929,702; 9,165,698; 9,322,704; 9,581,778 and 10,163,548, and US Published Applications 2015/0309271 and 2018/0052293, each of which is herein incorporated by reference.

### SUMMARY OF THE INVENTION

The applicant has appreciated drawbacks with the designs of the hybrid cables of the prior art.

With regard to the hybrid cable of U.S. Pat. No. 8,792,760, having eight different colors to distinguish eight separate insulated power conductors can be troublesome. According to colorblindawareness.org, approximately eight percent of men have a color vision deficiency of some type, i.e., approximately 1% deuteranopes, 1% protanopes, 1% protanomalous and 5% deuteranomalous. Depending upon the type of color distinction deficiency, people may have difficulty distinguishing between colors, like orange and red, or gray and blue.

Furthermore, the circumstances under which power cable terminations are made in the field, may be difficult. For example, with a ceiling-mounted enclosure, as shown in the Assignee's Ser. No. 63/295,624, filed Dec. 31, 2021, the person may be standing on a ladder with their head above the ceiling tiles and using a flashlight to illuminate the inside of a connection module. Therefore, distinguishing between eight different colors, without a clear line of sight and with a low level of artificial lighting may be troublesome.

The class 4 power cables offered by Belden cut down on the number of different colors needed to distinguish between the different insulated conductors transmitting power. With the cable of FIG. 1B, a first insulated conductor 82 has red insulation and a second insulated conductor 84 has black insulation, the two are twisted together to form the first twisted pair 83. A third insulated conductor 86 has white insulation and a fourth insulated conductor 88 has black insulation, the two are twisted together to form the second twisted pair 85. If third and fourth twisted pairs are added to the hybrid cable of Belden, the colors used for the third and fourth twisted pairs are “green twisted with black” and “blue twisted with black.” Half of the insulated power conductors have black insulation and are identical, but may be distinguished from each other because of the color of the insulated conductor, i.e., red, white, green or blue, to which the black insulated conductor is twisted. Hence, five colors can distinguish between eight insulated power conductors.

The twisting of pairs of insulated conductors is commonly used for twisted pair cables used to transmit data. The twisting scheme benefits the internal and alien crosstalk performance of the cable when transmitting high-speed data. When the insulated conductors are used to transmit power, crosstalk performance is not an issue to address.

When two insulated conductors are twisted together, a significant amount more of conductive material and insulative material is needed to produce a cable of a given length, as compared to a “straight run” of the two insulated conductors in a side-by-side arrangement without twisting. This added material occurs because with the twisting pattern, as each insulated conductor is zig-zagging back and forth in a lateral direction along the entire longitudinal length of the cable. The added materials increase the per-foot costs of the materials used in the cable and per-foot weight of the cable. More material within the cable increases the smoke emitted by the cable in case of a fire. The added material also increases the diameter of the cable. The increased diameter hinders the installation of the cable within conduits and general routing of the hybrid cable between the source and destination areas.

It is an object of the present invention to address the drawbacks appreciated above. These and other objectives are accomplished by a hybrid cable which includes at least two bonded pairs of electrical conductors, such as four bonded pairs. The bonded pairs may be stranded about a central member. In one embodiment, the central member is a glass reinforced plastic (GRP) rod, and one or two buffer tubes, each containing optical fibers, are stranded along with the bonded pairs about the GRP rod. In another embodiment, the central member is a tube and plural optical fibers, such as two groups of twelve optical fibers each, are contained within the tube. Each bonded pair of electrical conductors carry digital voltage or class 4 power from a transmitter card to a respective receiver card. Each bonded pair has unique indicia to facilitate the correct connections between the transmitter cards and the receiver cards. In one embodiment, the indicia include tactile physical features on an outer surface of one of the electrical conductors of each bonded pair.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

For a better understanding of the invention, and to show how the same may be carried into effect, reference will now be made, by way of example, to the accompanying drawings, in which:

FIG. 1A is a cross sectional view of a hybrid cable with electrical conductors and optical fibers, in accordance with the prior art;

FIG. 1B is a cross sectional view of a hybrid cable with twisted pairs of electrical conductors, in accordance with the prior art;

FIG. 2 is a perspective view of an end of a hybrid cable with a section of an outer jacket removed, in accordance with a first embodiment of the present invention;

FIG. 3 is a cross sectional view taken along line III-III in FIG. 2;

FIG. 4 is a cross sectional view, similar to FIG. 3, of a hybrid cable in accordance with a second embodiment of the present invention;

FIG. 5 is a cross sectional view, similar to FIGS. 3 and 4, of a hybrid cable in accordance with a third embodiment of the present invention;

FIG. 6 is a cross sectional view, similar to FIG. 5, of a hybrid cable in accordance with a fourth embodiment of the present invention;

FIG. 7 is a cross sectional view, similar to FIG. 6, of a hybrid cable in accordance with a fifth embodiment of the present invention;

FIG. 8 is a cross sectional view, similar to FIG. 7, of a hybrid cable in accordance with a sixth embodiment of the present invention;

FIG. 9 is a perspective view of an end of a hybrid cable with a section of an outer jacket removed, similar to FIG. 2, in accordance with a seventh embodiment of the present invention; and

FIG. 10 is a cross sectional view, similar to FIG. 7, of a hybrid cable in accordance with an eighth embodiment of the present invention.

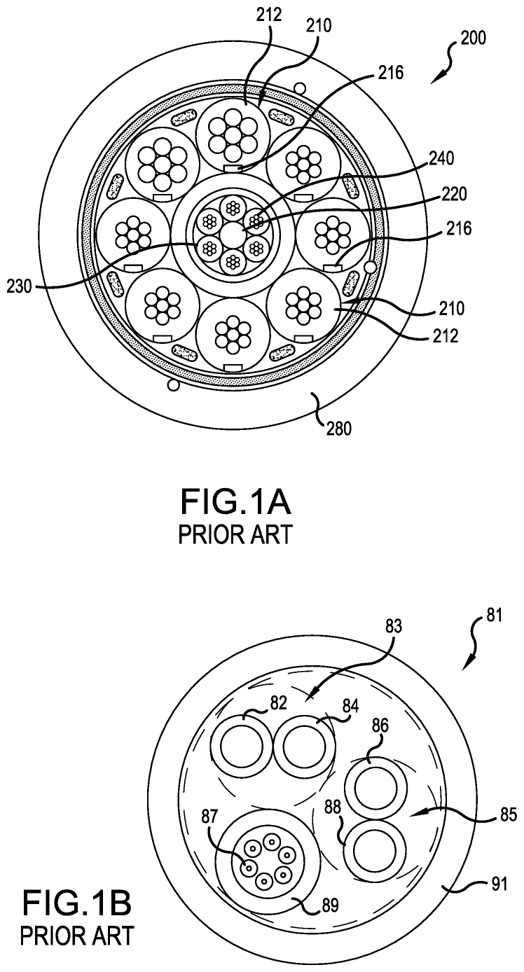

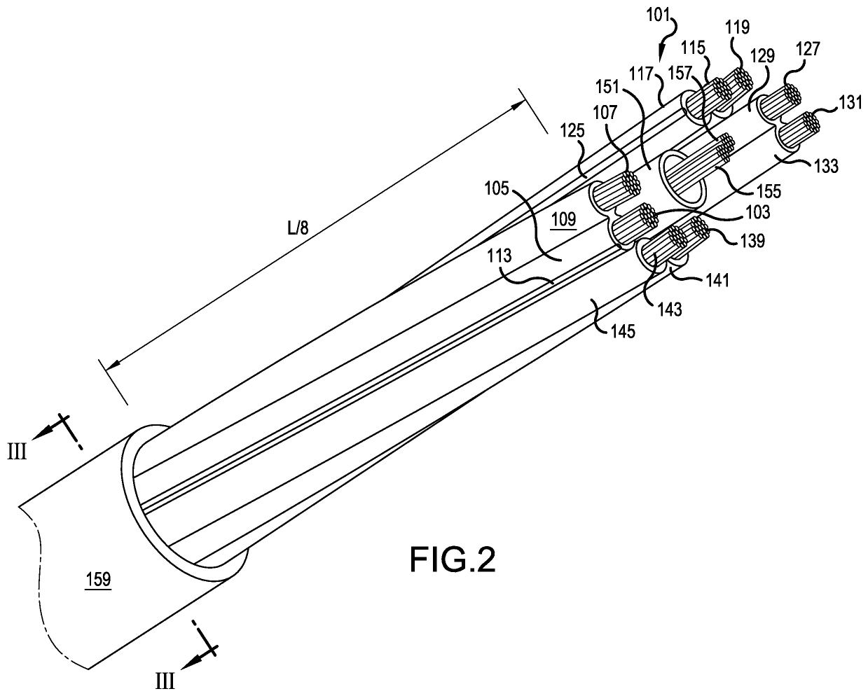

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

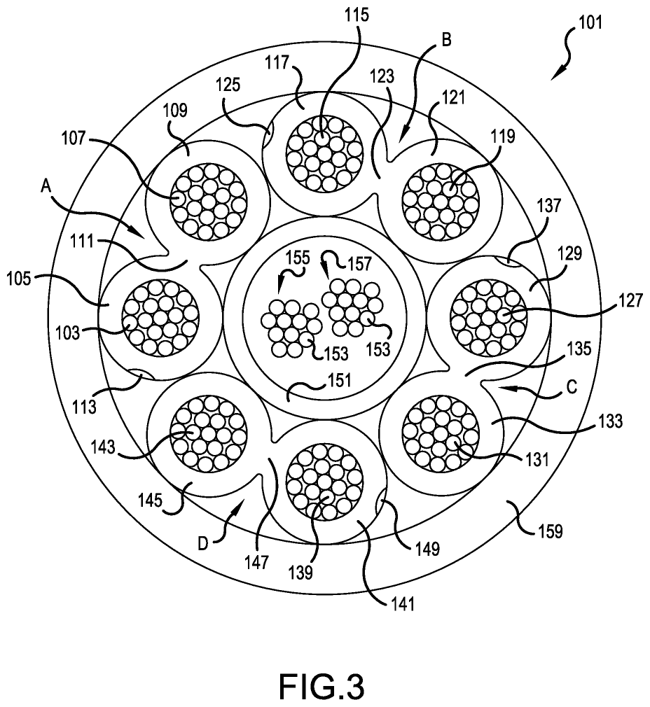

FIG. 2 is a perspective view of an end of a hybrid cable 101 and FIG. 3 is a cross sectional view taken along line III-III in FIG. 2. The hybrid cable 101 includes several power-carrying components and several data-carrying components. In a preferred embodiment, the power-carrying components transmit digital voltage, also called class 4 power, to plural cards within a voltage receiver.

For example, a first electrical conductor 103 is formed of a conductive metal or alloy and has a first insulation layer 105 surrounding and completely covering the first electrical conductor 103. A second electrical conductor 107 is formed of a conductive metal or alloy and has a second insulation layer 109 surrounding and completely covering the second electrical conductor 107. In a preferred embodiment, the first and second electrical conductors 103 and 107 are sized between twenty American wire gauge (AWG) and twelve AWG, more preferably between eighteen AWG and fourteen AWG.

The first and second electrical conductors 103 and 107 may each be formed as a stranded bunch of smaller wires, such as the nineteen smaller copper wires as show in FIGS. 2-3, or as a one-piece solid wire, e.g., copper or copper-clad-steel, as will be later described with reference to FIG. 9. In a preferred embodiment, the nineteen smaller copper wires are stranded to form first or second electrical conductors 103 or 107 having a sixteen AWG size. The stranded wires of the first and second electrical conductors 103 and 107 improve the current carrying capacity and the overall flexibility of the hybrid cable 101.

A first web 111 connects the first and second insulation layers 105 and 109 to form a first bonded pair A of electrical conductors 103 and 107. The first web 111 is formed of a same material used to form the first and second insulation layers 105 and 109 and is integrally formed along with the first and second insulation layers 105 and 109 during an extrusion process. The first bonded pair A of electrical conductors 103 and 107 also includes first indica. In the first embodiment of FIGS. 2 and 3, the first indica takes the form of a first color stripe or stripes 113, which contrasts with the base color of the first and second insulation layers 105 and 109. Instead of, or in additional to, the first color stripe or stripes 113, the first indica may also include text, such as letters, numbers, codes or symbols, printed on the outer surface of the first and/or second insulation layers 105 and/or 109. In a preferred embodiment, the first indica only appears on the outer surface of the first insulation layer 105, so as to distinguish the first electrical conductor 103 from the second electrical conductor 107 in the first bonded pair A of electrical conductors 103 and 107.

The hybrid cable 101 further includes a third electrical conductor 115 formed of a conductive metal or alloy having a third insulation layer 117 surrounding and completely covering the third electrical conductor 115. A fourth electrical conductor 119 is formed of a conductive metal or alloy and has a fourth insulation layer 121 surrounding and completely covering the fourth electrical conductor 119. The third and fourth electrical conductors 115 and 119 may be formed and sized the same as the first and second electrical conductors 103 and 107.

A second web 123 connects the third and fourth insulation layers 117 and 121 to form a second bonded pair B of electrical conductors 115 and 119. The second web 123 is formed of a same material used to form the third and fourth insulation layers 117 and 121 and is integrally formed along with the third and fourth insulation layers 117 and 121 during an extrusion process. The second bonded pair B of electrical conductors 115 and 119 includes second indica, which may take the form of a second color stripe or stripes 125, which contrasts with the base color of the third and fourth insulation layers 117 and 121 and has a different color as compared to the first color stripe or stripes 113. In a preferred embodiment, the second indica only appears on the outer surface of the third insulation layer 117, so as to distinguish the third electrical conductor 115 from the fourth electrical conductor 119 in the second bonded pair B of electrical conductors 115 and 119.

The hybrid cable 101 further includes a fifth electrical conductor 127 formed of a conductive metal or alloy having a fifth insulation layer 129 surrounding and completely covering the fifth electrical conductor 127. A sixth electrical conductor 131 is formed of a conductive metal or alloy and has a sixth insulation layer 133 surrounding and completely covering the sixth electrical conductor 131. The fifth and sixth electrical conductors 127 and 131 may be formed and sized the same as the first and second electrical conductors 103 and 107.

A third web 135 connects the fifth and sixth insulation layers 129 and 133 to form a third bonded pair C of electrical conductors 127 and 131. The third web 135 is formed of a same material used to form the fifth and sixth insulation layers 129 and 133 and is integrally formed along with the fifth and sixth insulation layers 129 and 133 during an extrusion process. The third bonded pair C of electrical conductors 127 and 131 includes third indica, which may take the form of a third color stripe or stripes 137, which contrasts with the base color of the fifth and sixth insulation layers 129 and 133 and has a different color as compared to the first color stripe or stripes 113 and the second color stripe or stripes 125. In a preferred embodiment, the third indica only appears on the outer surface of the fifth insulation layer 129, so as to distinguish the fifth electrical conductor 127 from the sixth electrical conductor 131 in the third bonded pair C of electrical conductors 127 and 131.

The hybrid cable 101 further includes a seventh electrical conductor 139 formed of a conductive metal or alloy having a seventh insulation layer 141 surrounding and completely covering the seventh electrical conductor 139. An eighth electrical conductor 143 is formed of a conductive metal or alloy and has an eighth insulation layer 145 surrounding and completely covering the eighth electrical conductor 143. The seventh and eighth electrical conductors 139 and 143 may be formed and sized the same as the first and second electrical conductors 103 and 107.

A fourth web 147 connects the seventh and eighth insulation layers 141 and 145 to form a fourth bonded pair D of electrical conductors 139 and 143. The fourth web 147 is formed of a same material used to form the seventh and eighth insulation layers 141 and 145 and is integrally formed along with the seventh and eighth insulation layers 141 and 145 during an extrusion process. The fourth bonded pair D of electrical conductors 139 and 143 includes fourth indica, which may take the form of a fourth color stripe or stripes 149, which contrasts with the base color of the seventh and eighth insulation layers 141 and 145 and has a different color as compared to the first color stripe or stripes 113, the second color stripe or stripes 125 and the third color stripe or stripe 137. In a preferred embodiment, the fourth indica only appears on the outer surface of the seventh insulation layer 141, so as to distinguish the seventh electrical conductor 139 from the eighth electrical conductor 143 in the fourth bonded pair D of electrical conductors 139 and 143.

In the embodiment of FIGS. 2 and 3, a central tube 151 resides in the center of the cable 101. The central tube 151 surrounds at least one optical fiber 153, such as at least eight optical fibers 153. In a preferred embodiment, the central tube 115 surrounds a first grouping 155 of twelve optical fibers 153 and a second grouping 157 of twelve optical fibers 153. Each grouping 155 and 157 of optical fibers 153 may be held together by an attachment to a rollable ribbon, or by an outer wrapping of one or more tapes and/or filaments, such as water absorbing tapes and/or water absorbing filaments or by small buffer tubes. Alternatively, the optical fibers 153 may be loose in the central tube 151, and a water blocking gel may optionally be disposed within the central tube 151. Optionally, a plurality of strength threads may be disposed within and/or surround the central tube 151, which may be considered a central buffer tube 151. The strength threads may be located within the small buffer tubes, if such small buffer tubes are used to separate the first and second groupings 155 and 157 of optical fibers 153. The plurality of strength threads may be formed of aramid yarns, sold under the trademark KELVAR®.

The first bonded pair A of electrical conductors 103 and 107, the second bonded pair B of electrical conductors 115 and 119, the third bonded pair C of electrical conductors 127 and 131 and the fourth bonded pair D of electrical conductors 139 and 143 extend alongside and surround the central tube 151 to form a core. Optionally, aramid fibers, such as Kevlar® fibers, one or more water blocking tapes, a core wrap and/or a shielding layer may then surround the core. Finally, a jacket 159 is extruded around and surrounds the core, and the optional elements surrounding the core, if provided.

To assist in the production of the cable 101 and hold the core together during assembly, e.g., as the jacket 159 is extruded over the core, the first, second, third and fourth bonded pairs A, B, C and D of electrical conductors may twist about the central tube 151 in a first direction to produce a core strand. A length at which the first, second, third and fourth bonded pairs A, B, C and D of electrical conductors twist about the central tube 151 three hundred sixty degrees is considered a core strand lay length L. FIG. 2 shows one eighth of the core strand lay length L/8. In a preferred embodiment, the core strand lay length L is six inches or greater, more preferably about twenty inches or greater. The first, second, third and fourth bonded pairs A, B, C and D of electrical conductors may also have a S-Z stranding pattern. In other words, the first, second, third and fourth bonded pairs A, B, C and D of electrical conductors twist about the central tube 151 in a first direction for plural revolutions and then reverse direction to twist about the central tube 151 in a second direction, opposite the first direction, for plural revolutions with the pattern of reversals repeating along the length of the cable 101.

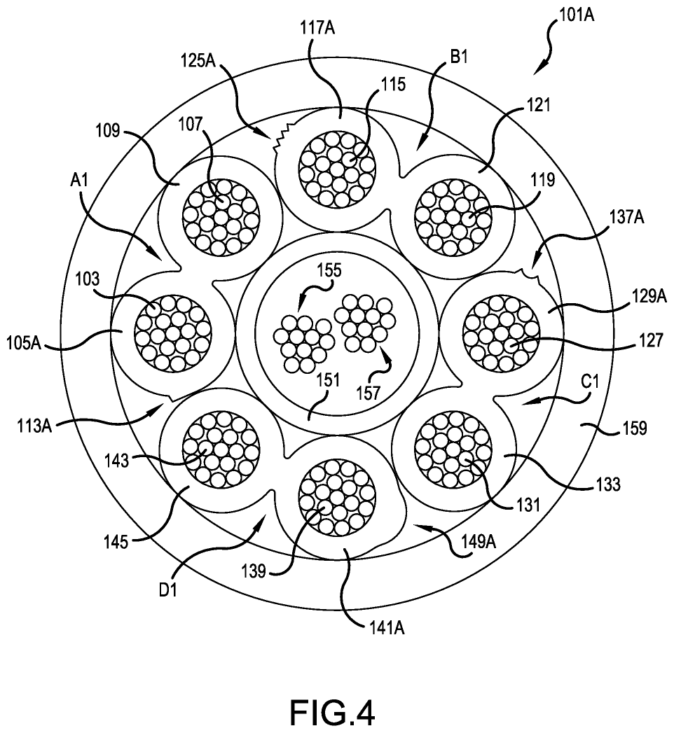

FIG. 4 is a cross sectional view, similar to FIG. 3, of a hybrid cable 101A in accordance with a second embodiment of the present invention. Identical elements have been labeled by the same reference numbers or have not been labeled.

The primary distinction is that the first electrical conductor 103 of the first bonded pair A1 of electrical conductors 103 and 107 has a different first indica. Namely, the first indicia includes a first tactile feature 113A formed on an outer surface of the first insulation layer 105A. The first tactile feature 113A may protrude from, or be recessed into, the outer surface of the first insulation layer 105A. The third, fifth and seventh insulation layers 117A, 129A and 141A of the second, third and fourth bonded pairs B1, C1 and D1 include second, third and fourth tactile features 125A, 137A and 149A.

The second tactile feature 125A is different from the first tactile feature 113A. The third tactile feature 137A is different from the first and second tactile features 113A and 125A. The fourth tactile feature 149A is different from the first, second and third tactile features 113A, 125A and 137A. For example, the first tactile feature 113A may be formed as a pointed shape protruding from the first insulation layer 105A, the second tactile feature 125A may be formed as four ridges protruding from the third insulation layer 117A, the third tactile feature 137A may be formed as two ridges protruding from the fifth insulation layer 129A, and the fourth tactile feature 149A may be formed as a rounded shape protruding from the seventh insulation layer 141A.

The first through the fourth tactile features 113A, 125A, 137A and 149A are advantageous as compared to the first through fourth color stripes 113, 125, 137 and 149. In instances wherein a clear line of sight to the terminations of the electrical conductors is not possible and/or the illumination is poor, a technician can feel the differences between the first through fourth tactile features 113A, 125A, 137A and 149A and still discriminate between the first through fourth bonded pairs A1, B1, C1 and D1. Because the first through the fourth tactile features 113A, 125A, 137A and 149A are only present on one of the electrical conductors of each bonded pair A1, B1, C1 or D1, the technician can also discriminate between the positive and negative electrical conductors of each bonded pair A1, B1, C1 and D1.

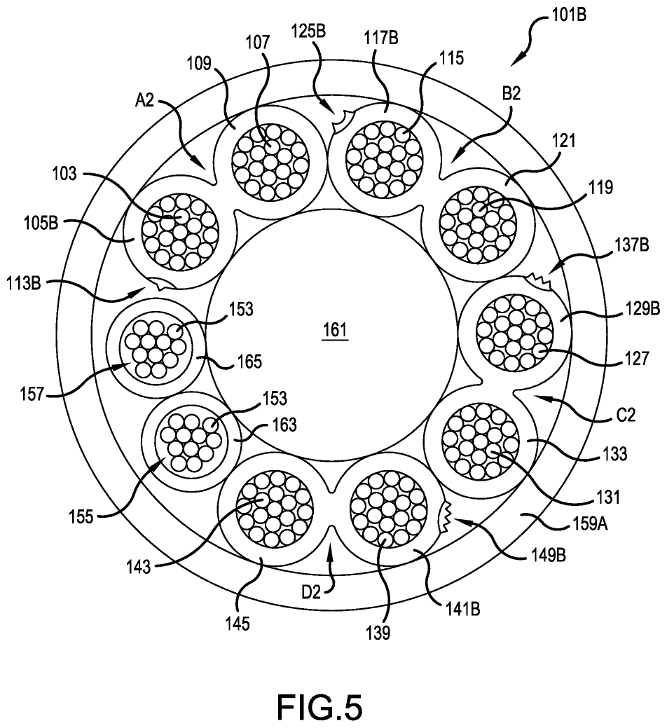

FIG. 5 is a cross sectional view, similar to FIGS. 3 and 4, of a hybrid cable 101B in accordance with a third embodiment of the present invention. Identical elements have been labeled by the same reference numbers or have not been labeled.

The primary distinction is that the central tube 151 has been replaced by a central strength member 161. In a preferred embodiment, the central strength member 161 is formed as a flexible, glass reinforced plastic (GRP) rod, or a dielectric rod, or a stranded messenger-type wire, which could be used to establish a common ground between the source and destination.

The first group 155 of optical fibers 153 is surrounded by a first buffer tube 163. The second group 157 of optical fibers 153 is surrounded by a second buffer tube 165. Each of the first and second buffer tubes 163 and 165 may also include a plurality of strength threads, such as aramid yarns, sold under the trademark KELVAR®. The first and second buffer tubes 163 and 165 extend alongside the central strength member 161 as part of the core surrounded by the jacket 159A, which may have a larger diameter than the jacket 159 of the embodiment of FIGS. 3 and 4. Further, the first and second buffer tubes 163 and 165 may be stranded along with the first through fourth bonded pairs A2, B2, C2 and D2 about the central strength member 161, using one of the methods described above.

FIG. 5 also illustrates that different color stripes may be combined with different tactile features so that the different colors may be relied upon when visibility is good to distinguish between the first through fourth bonded pairs A2, B2, C2 and D2, and the different tactile features may be relied upon to distinguish between the first through fourth bonded pairs A2, B2, C2 and D2 when visibility is impaired. In particular, the first tactile feature 113B includes a first number of ridges, e.g., a single ridge, protruding from an outer surface of the first insulation layer 105B. The single ridge may be formed as an extruded color stripe, e.g., a red stripe. The second tactile feature 125B includes a second number of ridges, e.g., two ridges, protruding from an outer surface of the third insulation layer 117B. The two ridges may be formed as an extruded color stripe, e.g., a white stripe, so as to distinguish the first bonded pair A2 of electrical conductors 103 and 107 from the second bonded pair B2 of electrical conductors 115 and 119.

In similar fashion, the third tactile feature 137B includes a third number of ridges, e.g., three ridges, protruding from an outer surface of the fifth insulation layer 129B. The three ridges may be formed as an extruded color stripe, e.g., a blue stripe. The fourth tactile feature 149B includes a fourth number of ridges, e.g., four ridges, protruding from an outer surface of the seventh insulation layer 141B. The four ridges may be formed as an extruded color stripe, e.g., a green stripe. In the embodiment of FIG. 5, the second number of ridges is different from the first number of ridges, the third number of ridges is different from the first and second numbers of ridges, and the fourth number of ridges is different from the first, second and third numbers of ridges.

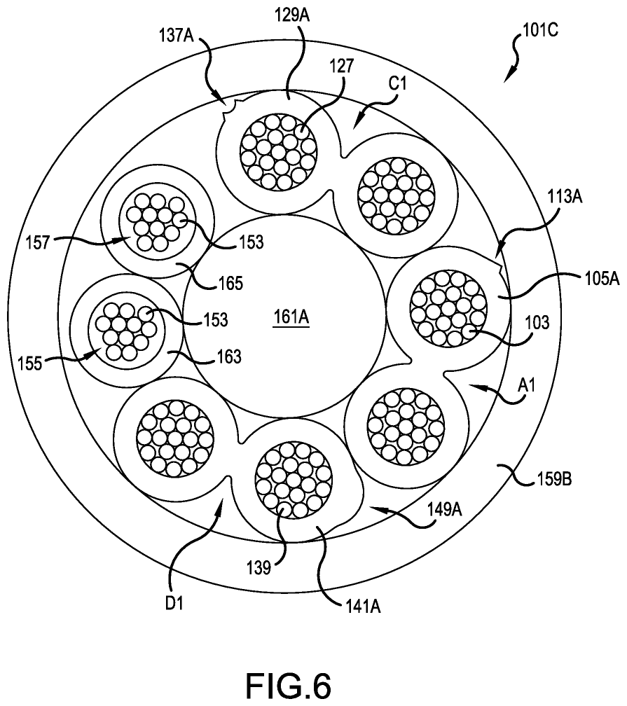

FIG. 6 is a cross sectional view, similar to FIG. 5, of a hybrid cable 101C in accordance with a fourth embodiment of the present invention. Identical elements have been labeled by the same reference numbers or have not been labeled.

The primary distinction between FIGS. 6 and 5 is that cable 101C includes a smaller diameter central strength member 161A and only three bonded pairs, namely the first, third and fourth bonded pairs A1, C1 and D1 of FIG. 4. Since only three bonded pairs A1, C1 and D1 are included, the outer jacket 159B may have a smaller diameter as comparted to the jackets 159 and 159A of FIGS. 4 and 5. If only three power transmission and reception cards are to be utilized to send class 4 power from the source to the destination, the hybrid cable 101C would be suitable.

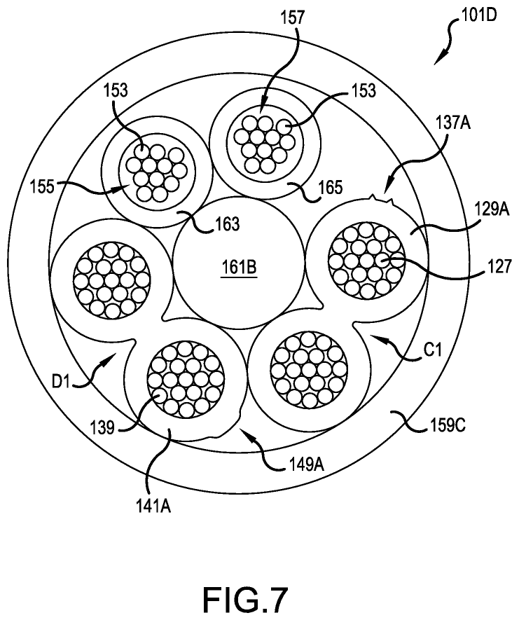

FIG. 7 is a cross sectional view, similar to FIG. 6, of a hybrid cable 101D in accordance with a fifth embodiment of the present invention. Identical elements have been labeled by the same reference numbers or have not been labeled.

The primary distinction between FIGS. 7 and 6 is that cable 101D includes an even smaller diameter central strength member 161B and only two bonded pairs, namely the third and fourth bonded pairs C1 and D1 of FIG. 4. Since only two bonded pairs C1 and D1 are included, the outer jacket 159C may have a smaller diameter as comparted to the jackets 159, 159A and 159B of FIGS. 3-6. If only two power transmission and reception cards are to be utilized to send class 4 power from the source to the destination, the hybrid cable 101D would be suitable.

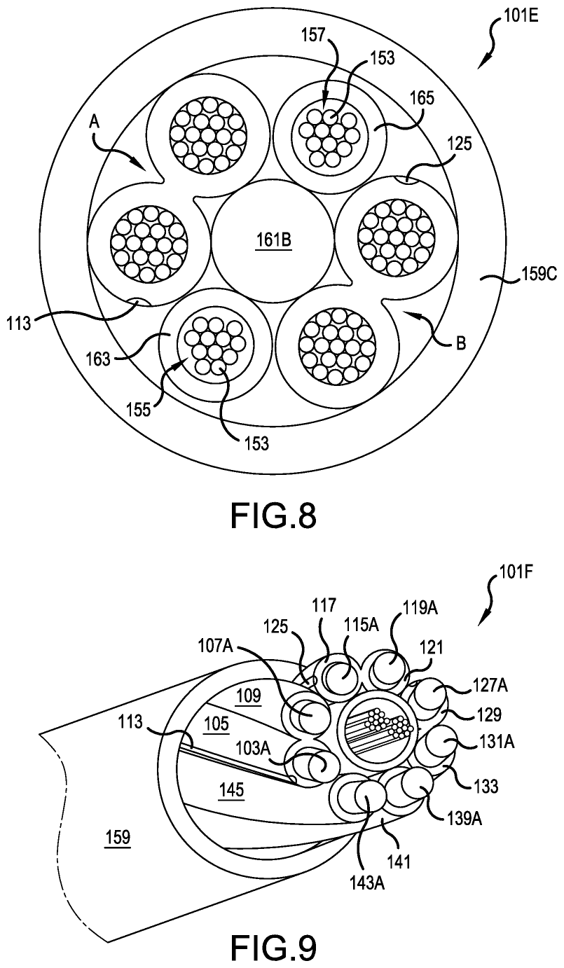

FIG. 8 is a cross sectional view, similar to FIG. 7, of a hybrid cable 101E in accordance with a sixth embodiment of the present invention. Identical elements have been labeled by the same reference numbers or have not been labeled.

The primary distinction between FIGS. 8 and 7 is that cable 101E includes two different bonded pairs, namely the first and second bonded pairs A and B of FIG. 3. The first and second bonded pairs A and B do not include the tactile features, just the different colored stripes 113 and 125. Moreover, FIG. 8 illustrates that the first and second buffer tubes 163 and 165 need not be side-by-side in the cable core, but rather may be spaced apart within the cable core by the bonded pairs A and B. Again, if only two power transmission and reception cards are to be utilized to send class 4 power from the source to the destination, the hybrid cable 101E would be suitable.

FIG. 9 is a perspective view of an end of a hybrid cable 101F with a section of the outer jacket 159 removed, in accordance with a seventh embodiment of the present invention. FIG. 9 illustrates that the first through eighth electrical conductors 103, 107, 115, 119, 127, 131, 139 and 143, which are formed as stranded bunches of smaller wires, such as the nineteen smaller copper wires, may instead be formed as one-piece solid electrical conductors. Namely, FIG. 9 shows first through eighth electrical conductors 103A, 107A, 115A, 119A, 127A, 131A, 139A and 143A, each formed as a one-piece solid wire, e.g., copper or copper-clad-steel.

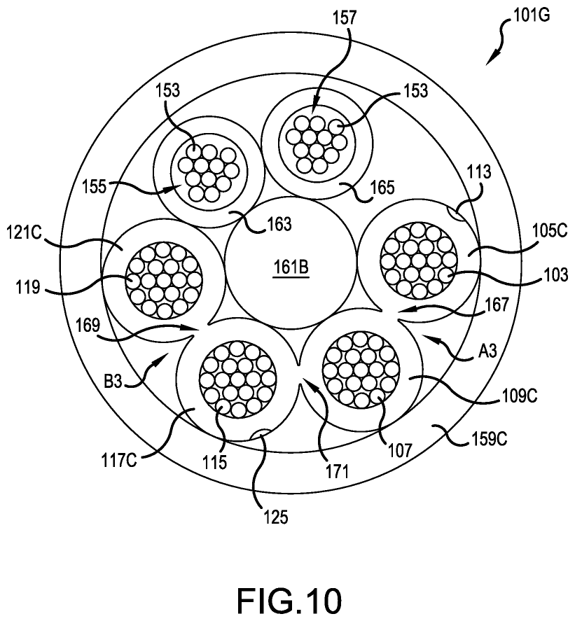

FIG. 10 is a cross sectional view, similar to FIG. 7, of a hybrid cable 101G in accordance with an eighth embodiment of the present invention. Identical elements have been labeled by the same reference numbers or have not been labeled. The hybrid cable 101G includes the first electrical conductor 103 with a first insulation layer 105C surrounding and completely covering the first electrical conductor 103, and the second electrical conductor 107 with a second insulation layer 109C surrounding and completely covering the second electrical conductor 107.

A first web 167 connects the first and second insulation layers 105C and 109C to form a first bonded pair A3 of electrical conductors 103 and 107. The first web 167 is formed of a same material used to form the first and second insulation layers 105C and 109C and is integrally formed along with the first and second insulation layers 105C and 109C during an extrusion process. The first bonded pair A3 of electrical conductors 103 and 107 also includes first indica in the form of the first color stripe or stripes 113.

The hybrid cable 101G further includes the third electrical conductor 115 with a third insulation layer 117C surrounding and completely covering the third electrical conductor 115, and the fourth electrical conductor 119 with a fourth insulation layer 121C surrounding and completely covering the fourth electrical conductor 119.

A second web 169 connects the third and fourth insulation layers 117C and 121C to form a second bonded pair B3 of electrical conductors 115 and 119. The second web 169 is formed of a same material used to form the third and fourth insulation layers 117C and 121C and is integrally formed along with the third and fourth insulation layers 117C and 121C during an extrusion process. The second bonded pair B3 of electrical conductors 115 and 119 also includes second indica in the form of the second color stripe or stripes 125. Of course, the first indica and the second indica may alternatively be formed as tactile features, or combinations of color features and tactile features, as discussed in relation to the other embodiments herein.

Of note in the hybrid cable 101G is a connecting web 171. The connecting web 171 connects the first bonded pair A3 to the second bonded pair B3. More particularly, the connecting web 171 connects the second insulation layer 109C of the first bonded pair A3 to the third insulation layer 117C of the second bonded pair B3. The connecting web 171 is formed of a same material used to form the first, second, third and fourth insulation layers 105C, 109C, 117C and 121C and is integrally formed along with the first, second, third and fourth insulation layers 105C, 109C, 117C and 121C during an extrusion process. By virtue of the connecting web 171, the power transmission components of the hybrid cable 101G will remain connected together after the outer jacket 159C is removed, and the power transmission components may be routed as a group to power transmission and reception cards utilized to send class 4 power from the source to the destination.

If only two power transmission and reception cards are to be utilized to send class 4 power from the source to the destination, the hybrid cable 101G would be suitable. If three power transmission and reception cards are to be utilized to send class 4 power from the source to the destination, then a third bonded pair of electrical conductors would be added to the hybrid cable 101G and a second connecting web would connect the second bonded pair B3 to the third bonded pair. If four power transmission and reception cards are to be utilized to send class 4 power from the source to the destination, then a fourth bonded pair of electrical conductors would be added to the hybrid cable 101G and a third connecting web would connect the third bonded pair to the fourth bonded pair. It would also be possible to place the fibers 153 in a central buffer tube 151, as shown in FIGS. 2-4 and 9, and remove the first and second buffer tubes 163 and 165 to allow more space for any third or four bonded pairs.

In the above embodiments, the optical fibers 153 may all be of a single mode type, may all be of a multimode type, or may be a mixture of the two types. Further, one or more rip cords, formed of strong threads or wires, may be included within the cables 101, 101A, 101B, 101C, 101D, 101E, 101F and 101G to assist with opening the jackets 159, 159A, 159B or 159C and/or the buffer tubes 151, 163 and 165.

The invention being thus described, it will be obvious that the same may be varied in many ways.

We claim:

1. A hybrid cable comprising:
a first electrical conductor formed of a conductive metal or alloy with a first insulation layer surrounding said first electrical conductor;
a second electrical conductor formed of a conductive metal or alloy with a second insulation layer surrounding said second electrical conductor;
a first web connecting said first and second insulation layers to form a first bonded pair of electrical conductors;
a third electrical conductor formed of a conductive metal or alloy with a third insulation layer surrounding said third electrical conductor;
a fourth electrical conductor formed of a conductive metal or alloy with a fourth insulation layer surrounding said fourth electrical conductor;
a second web connecting said third and fourth insulation layers to form a second bonded pair of electrical conductors;
at least one optical fiber surrounded by a tube;
a central strength member, wherein said first bonded pair of electrical conductors, said second bonded pair of electrical conductors and said tube with at least one optical fiber therein surround said central strength member to form a core; and
a jacket surrounding said core.

2. The hybrid cable according to claim 1, wherein said tube is a first buffer tube and said at least one optical fiber is a first plurality of optical fibers surrounded by said first buffer tube, and further comprising:
a second buffer tube and a second plurality of optical fibers surrounded by said second buffer tube, wherein said second buffer tube extends alongside said central strength member as part of said core surrounded by said jacket.

3. The hybrid cable according to claim 1, wherein said central strength member is formed by a glass reinforced plastic (GRP) rod.

4. The hybrid cable according to claim 1, wherein said first, second, third and fourth electrical conductors are each sixteen American wire gauge (AWG) in diameter.

5. The hybrid cable according to claim 1, wherein said first web is formed of a same material used to form said first and second insulation layers and is integrally formed with said first and second insulation layers during an extrusion process; and
wherein said second web is formed of a same material used to form said third and fourth insulation layers and is integrally formed with said third and fourth insulation layers during an extrusion process.

6. The hybrid cable according to claim 5, further comprising:
a connecting web attaching said first bonded pair to said second bonded pair, and wherein said connecting web is formed of a same material used to form said first, second, third and fourth insulation layers and is integrally formed with said first, second, third and fourth insulation layers during an extrusion process.

7. The hybrid cable according to claim 1, wherein said first bonded pair of electrical conductors includes first indica, in the form of at least one of a color stripe, text or tactile feature, and said second bonded pair of electrical conductors includes second indica, different from said first indica.

8. The hybrid cable according to claim 7, wherein said first indicia includes a first tactile feature and said second indicia includes a second tactile feature, different from said first tactile feature, and wherein said first tactile feature is formed on an outer surface of said first insulation layer so as to distinguish said first electrical conductor from said second electrical conductor in said first bonded pair of electrical conductors, and wherein said second tactile feature is formed on an outer surface of said third insulation layer so as to distinguish said third electrical conductor from said fourth electrical conductor in said second bonded pair of electrical conductors.

9. The hybrid cable according to claim 1, further comprising:
a fifth electrical conductor formed of a conductive metal or alloy with a fifth insulation layer surrounding said fifth electrical conductor;
a sixth electrical conductor formed of a conductive metal or alloy with a sixth insulation layer surrounding said sixth electrical conductor;
a third web connecting said fifth and sixth insulation layers to form a third bonded pair of electrical conductors, wherein said third bonded pair of electrical conductors extends alongside said central strength member as part of said core surrounded by said jacket;
a seventh electrical conductor formed of a conductive metal or alloy with a seventh insulation layer surrounding said seventh electrical conductor;
an eighth electrical conductor formed of a conductive metal or alloy with an eighth insulation layer surrounding said eighth electrical conductor; and
a fourth web connecting said seventh and eighth insulation layers to form a fourth bonded pair of electrical conductors, wherein said fourth bonded pair of electrical conductors extends alongside said central strength member as part of said core surrounded by said jacket.

10. The hybrid cable according to claim 9, wherein said first, second, third and fourth bonded pairs of electrical conductors twist about said central strength member in a first direction to produce a core strand, and where a length at which said first, second, third and fourth bonded pairs of electrical conductors twist about said central strength member three hundred sixty degrees is considered a core strand lay, and wherein said core strand lay is six inches or greater.

11. The hybrid cable according to claim 10, wherein said core strand lay is twenty inches or greater.

12. A hybrid cable comprising:
a first electrical conductor formed of a conductive metal or alloy with a first insulation layer surrounding said first electrical conductor;
a second electrical conductor formed of a conductive metal or alloy with a second insulation layer surrounding said second electrical conductor;
a first web connecting said first and second insulation layers to form a first bonded pair of electrical conductors;
a third electrical conductor formed of a conductive metal or alloy with a third insulation layer surrounding said third electrical conductor;
a fourth electrical conductor formed of a conductive metal or alloy with a fourth insulation layer surrounding said fourth electrical conductor;
a second web connecting said third and fourth insulation layers to form a second bonded pair of electrical conductors;
at least one optical fiber surrounded by a tube, wherein said tube is a central tube, and wherein said first bonded pair of electrical conductors and said second bonded pair of electrical conductors surround said central tube to form a core; and
a jacket surrounding said core.

13. The hybrid cable according to according to claim 12, wherein said first web is formed of a same material used to form said first and second insulation layers and is integrally formed with said first and second insulation layers during an extrusion process; and
wherein said second web is formed of a same material used to form said third and fourth insulation layers and is integrally formed with said third and fourth insulation layers during an extrusion process.

14. The hybrid cable according to claim 13, further comprising:
a connecting web attaching said first bonded pair to said second bonded pair, wherein said connecting web is formed of a same material used to form said first, second, third and fourth insulation layers and is integrally formed with said first, second, third and fourth insulation layers during an extrusion process.

15. The hybrid cable according claim 12, wherein said first bonded pair of electrical conductors includes first indica, in the form of a color stripe, text or tactile feature, and said second bonded pair of electrical conductors includes second indica, different from said first indica.

16. The hybrid cable according to claim 15, wherein said first indicia is a first tactile feature and said second indicia is a second tactile feature.

17. The hybrid cable according to claim 16, wherein said first tactile feature is formed on an outer surface of said first insulation layer so as to distinguish said first electrical conductor from said second electrical conductor in said first bonded pair of electrical conductors, and wherein said second tactile feature is formed on an outer surface of said third insulation layer so as to distinguish said third electrical conductor from said fourth electrical conductor in said second bonded pair of electrical conductors.

18. The hybrid cable according to claim 12, further comprising:
a fifth electrical conductor formed of a conductive metal or alloy with a fifth insulation layer surrounding said fifth electrical conductor;
a sixth electrical conductor formed of a conductive metal or alloy with a sixth insulation layer surrounding said sixth electrical conductor;
a third web connecting said fifth and sixth insulation layers to form a third bonded pair of electrical conductors, wherein said third bonded pair of electrical conductors extends alongside said central tube as part of said core surrounded by said jacket;
a seventh electrical conductor formed of a conductive metal or alloy with a seventh insulation layer surrounding said seventh electrical conductor;
an eighth electrical conductor formed of a conductive metal or alloy with an eighth insulation layer surrounding said eighth electrical conductor; and
a fourth web connecting said seventh and eighth insulation layers to form a fourth bonded pair of electrical conductors, wherein said fourth bonded pair of electrical conductors extends alongside said central tube as part of said core surrounded by said jacket.

19. The hybrid cable according to claim 18, wherein said first bonded pair of electrical conductors includes first indica, in the form of a color stripe, text or tactile feature, said second bonded pair of electrical conductors includes second indica, different from said first indica, said third bonded pair of electrical conductors includes third indica, different from said first indica and said second indicia, and said fourth bonded pair of electrical conductors includes fourth indica, different from said first indica, said second indicia and said third indica.

20. The hybrid cable according to claim 19, wherein said first, second, third and fourth bonded pairs of electrical conductors twist about said central tube in a first direction to produce a core strand, and where a length at which said first, second, third and fourth bonded pairs of electrical conductors twist about said central tube three hundred sixty degrees is considered a core strand lay, and wherein said core strand lay is six inches or greater.
